(19) United States
(12) Patent Application Publication
(10) Pub. No.: US 2026/0310415 A1
(43) Pub. Date: Oct. 8, 2026

(54) GRAND UNIFIED MODULAR ARITHMETIC FRAMEWORK

(71) Applicants: Bo Payne, College Grove, TN (US); Nathan Reeve, Cypress, TX (US)

(72) Inventors: Bo Payne, College Grove, TN (US); Nathan Reeve, Cypress, TX (US)

(21) Appl. No.: 19/172,796

(22) Filed: Apr. 8, 2025

(51) Int. Cl. G06F 7/72

(52) U.S. Cl. CPC G06F 7/72; G06F 7/49905; G06F 7/49926

(57) ABSTRACT

The present invention is directed to a grand unified modular arithmetic framework (GUMAF) that transforms modular arithmetic, factorization, and recursive number structures by introducing a zero-free arithmetic system (Cyc(9)), which replaces 0 with 9 to maintain perfect numerical continuity. More specifically, by restructuring number theory through a self-replicating, fractal-like modular system, GUMAF provides predictive rules for prime distribution, semi-prime growth, and modular periodicity. In addition, GUMAF comprises a zero-free, Cyc(9) modular arithmetic system ensuring that all modular cycles remain closed and self-contained; a self-referencing multiplication lattice, where prime and semi-prime positioning follows recursive diagonal symmetry; new laws of factorization, including reverse modular decomposition, prime anchoring, and modular prime-semi-prime relationships; and a fractal expansion model for modular summations, ensuring that digital roots and modular residues follow predictable, periodic laws.

### FIELD OF THE INVENTION

The present invention is directed to a grand unified modular arithmetic framework (GUMAF) that transforms modular arithmetic, factorization, and recursive number structures by introducing a zero-free arithmetic system (Cyc(9)), which replaces 0 with 9 to maintain perfect numerical continuity. More specifically, by restructuring number theory through a self-replicating, fractal-like modular system, GUMAF provides predictive rules for prime distribution, semi-prime growth, and modular periodicity. In addition, GUMAF comprises a zero-free, Cyc(9) modular arithmetic system ensuring that all modular cycles remain closed and self-contained; a self-referencing multiplication lattice, where prime and semi-prime positioning follows recursive diagonal symmetry; new laws of factorization, including reverse modular decomposition, prime anchoring, and modular prime-semi-prime relationships; and a fractal expansion model for modular summations, ensuring that digital roots and modular residues follow predictable, periodic laws.

### BACKGROUND OF THE INVENTION

One of the limitations in traditional number theory is that modular congruences often suffer from singularities, undefined operations, and inconsistencies in cyclic behavior as a result of being a zero-centered system. Likewise, traditional number systems suffer from singularities, undefined operations, and exponential complexity in factorization.

Problems in traditional modular arithmetic include factorization remains an exponential problem, zero introduces undefined modular structures and gaps in cyclic computation, and prime placement appears random, rather than following structured modular patterns.

In computing and cryptography, current systems are subject to computational overflow and rounding errors.

Therefore, there exists a need for a zero-free modular arithmetic framework that reduces processing overhead by ensuring closed arithmetic operations, eliminates undefined values in simulations of quantum and relativistic systems, and offers more stable numerical frameworks resistant to rounding errors and computational drift.

### SUMMARY OF THE INVENTION

The present invention is directed to a grand unified modular arithmetic framework (GUMAF) that transforms modular arithmetic, factorization, and recursive number structures by introducing a zero-free arithmetic system (Cyc(9)), which replaces 0 with 9 to maintain perfect numerical continuity. More specifically, by restructuring number theory through a self-replicating, fractal-like modular system, GUMAF provides predictive rules for prime distribution, semi-prime growth, and modular periodicity. In addition, GUMAF comprises a zero-free, Cyc(9) modular arithmetic system ensuring that all modular cycles remain closed and self-contained; a self-referencing multiplication lattice, where prime and semi-prime positioning follows recursive diagonal symmetry; new laws of factorization, including reverse modular decomposition, prime anchoring, and modular prime-semi-prime relationships; and a fractal expansion model for modular summations, ensuring that digital roots and modular residues follow predictable, periodic laws.

In an exemplary embodiment, the grand unified modular arithmetic framework to improve modular arithmetic, factorization, and recursive number structures used in digital computing comprises a core mathematical structure, wherein said core mathematical structure comprises: addition, wherein said addition comprises: a⊕b=((a+b−1) mod 9)+1; multiplication, wherein said multiplication comprises: a⊗b=((a×b−1) mod 9)+1; division, wherein said division comprises a definition of an inverse function: \text {custom_inverse} (b)=\begin {cases} 9-b, & \text {if} 1 \leq b \leq 8\9, & \text {if} b=9 \end {cases}; and exponentiation, wherein said exponentiation comprises aⁿ=a⊗a⊗a . . . (n times).

In an alternate embodiment, the grand unified modular arithmetic framework further comprises a formula for fractal digital root consistency.

In one embodiment, the formula for fractal digital root consistency comprises:

$$d r ( N ) = \{ \begin{matrix}9 , & if N ≡ 0 mod 0 \\ N mod 9 , & otherwise\end{matrix} .$$

In an alternate embodiment, the formula for fractal digital root consistency comprises: dr(N)=Σdigits of N mod 9.

In an alternate embodiment, the formula for fractal digital root consistency comprises: dr(N)=N×10^{-k} mod 9, k=length of N.

In an alternate embodiment, the formula for fractal digital root consistency comprises:

$$d r ( N ) = {\sum }_{i = 1}^{∞} \frac{N}{{9}^{i}} mod 9.$$

In yet another embodiment, the grand unified modular arithmetic framework further comprises a scalable anchoring principle. In one embodiment, the scalable anchoring principle comprises 1296.

In an alternate embodiment, the scalable anchoring principle comprises any multiple of 1296 with a digital root of 9.

In one embodiment, the grand unified modular arithmetic framework further comprises axiomatic foundations of modular congruences.

In yet another embodiment, the axiomatic foundations of modular congruences comprises: (1) modular congruence, wherein said modular congruence comprises For any x, if x=0 (mod 9), redefine x=9 (mod 9); (2) multiplication congruence, wherein said multiplication congruence comprises a×b≡(a mod 9)×(b mod 9) (mod 9); (3) digital root function, wherein said digital root function comprises dr(x): dr(a×b)=dr(a)×dr(b) (mod 9); (4) fractal modular expansion, wherein said fractal modular expansion comprises dr(a²+b²)=dr(a)⊕dr(b); and (5) three-dimensional fractal modular expansion, wherein said three-dimensional fractal modular expansion comprises dr(x²+y²+z²)=dr(x)⊕dr(y)⊕dr(z).

In another embodiment, the grand unified modular arithmetic framework further comprises: a multiplication lattice, wherein said multiplication lattice comprises dr(D(n))=dr(n)⊗dr(n); an anti-diagonal, wherein said anti-diagonal comprises A(n)=10−D(n) (mod 9); and a modular prime anchor, wherein said modular prime anchor comprises M²−Δ²=N, where p=M−Δ, q=M+Δ.

In one embodiment, the grand unified modular arithmetic framework further comprises: a logarithmic scaling of modular growth, wherein said logarithmic scaling of modular growth comprises dr(10ⁿ)=dr(n×9); and a modular residue growth in higher dimensions, wherein said modular residue growth in higher dimensions comprises dr(x²+y²+z²)=dr(x) @dr(y)⊕dr(z).

In yet another embodiment, the grand unified modular arithmetic framework further comprises: a summation law for modular residue preservation comprising ΣSₚ=n², dr(ΣSₚ)=9; a modular summation law comprising

$${\sum }_{i = 1}^{n} {S}_{p} = 9 \times k ;$$

a collapsible summation sequence comprising dr(ΣSₚ)=9; and a logarithmic recursive expansion comprising dr(10ⁿ)=dr(n×9).

In an alternate embodiment, the core mathematical structure comprises the following steps: establishing the self-contained numerical structure that ensures consistency across modular computations; representing each number from a universal key ensuring values remain within a structured numerical cycle; replacing traditional arithmetic with zero-free modular arithmetic eliminating undefined operations; creating a closed set of {1-9} for all basic operations including addition, multiplication, and exponentiation ensuring zero-based anomalies do not exist in the framework; ensuring prime numbers only appear in specified modular sequences eliminating residue and confirming a structured sieve for prime prediction; ensuring digital root transformations maintain modular structure across infinite scales; introducing structured periodicity in squared, cubic, and factorial lattices expanding into higher-dimensional modular systems; and validating said core mathematical structure using computational models.

In one embodiment, the mathematical structure comprises the following steps: introducing Cyc(9) activation functions eliminating issues with gradient explosion, vanishing effects, and floating point drift; ensuring bounded activations preventing divergence, modular periodicity allowing stable deep-learning recursion, and error-free optimization removing floating-point instability; introducing modular cryptographic transformations resisting quantum attacks; reformulating wave functions using modular trigonometry preventing qubit collapse and maintaining stable resonance cycles; applying modular lattice transformations ensuring high-performance computing; providing multiple solutions to common problems in traditional computation; and providing a structured, modular, and overflow-free computational framework ensuring AI neural network stability with Cyc(9) activation functions, post-quantum encryption security using modular cryptographic scaling, high-performance modular computation ensuring infinite scaling, and comprehensive structured inversion ensuring perfect modular reversibility.

In one embodiment, the amended mathematical structure comprises the following steps: validating the SCG-based modular inverse function ensuring that all operations remain within modular containment without undefined division errors; comparing modular inversion methods to ensure most effective method for each computational applications; and using Cyc(9) modular activation function to maintain structured, periodic activation cycles.

Various objects, features, aspects, and advantages of the inventive subject matter will become more apparent from the following detailed description of exemplary embodiments, along with the accompanying figures in which like numerals represent like components.

### BRIEF DESCRIPTION OF DRAWINGS

FIG. 1 depicts the mathematical structure used in an exemplary embodiment of the grand unified modular arithmetic framework.

FIG. 2 depicts the fractal digital root consistency used in an exemplary embodiment of the grand unified modular arithmetic framework.

FIG. 3 depicts the scalable anchoring principle used in an exemplary embodiment of the grand unified modular arithmetic framework.

FIG. 4 depicts the axiomatic foundations used in an exemplary embodiment of the grand unified modular arithmetic framework.

FIG. 5 depicts the multiplication lattice and the prime factorization laws used in an exemplary embodiment of the grand unified modular arithmetic framework.

FIG. 6 depicts the advanced modular laws and fractal properties used in an exemplary embodiment of the grand unified modular arithmetic framework.

FIG. 7 depicts the summations laws and the digital root fractals used in an exemplary embodiment of the grand unified modular arithmetic framework.

FIG. 8A depicts a graph of the comparative analysis of three digital root computation methods.

FIG. 8B depicts a graph of the comparison of multiplication methods used in zero-free modular arithmetic.

FIG. 9A depicts a chart of the validation test results for the grand unified modular arithmetic framework.

FIG. 9B depicts a chart of the fractal digital root stability across scales for the grand unified modular arithmetic framework.

FIG. 10A depicts a chart of the zero-free modular consistency over large number ranges for the grand unified modular arithmetic framework.

FIG. 10B depicts a bar chart of the performance comparison of alternative computation methods.

FIG. 11A depicts a bar chart of the performance benchmark validation tests for the grand unified modular arithmetic framework.

FIG. 11B depicts a chart of the fractal digital root stability across large number scales for the grand unified modular arithmetic framework.

FIG. 12 depicts a chart of the 1296 scaling test for digital root stability for the grand unified modular arithmetic framework.

FIG. 13 depicts the core mathematical framework for an exemplary embodiment of the grand unified modular arithmetic framework.

FIG. 14 depicts the core mathematical framework for an exemplary embodiment of the grand unified modular arithmetic framework.

FIG. 15 depicts the core mathematical framework for an exemplary embodiment of the grand unified modular arithmetic framework.

FIG. 16 depicts the mathematical framework for an exemplary embodiment of the grand unified modular arithmetic framework used in modular computation, intelligence, cryptography, and quantum computing.

FIG. 17 depicts the mathematical framework for an exemplary embodiment of the grand unified modular arithmetic framework used in modular computation, artificial intelligence, cryptography, and quantum computing.

FIG. 18 depicts the mathematical framework for an exemplary embodiment of the grand unified modular arithmetic framework used in modular computation, artificial intelligence, cryptography, and quantum computing.

FIG. 19 depicts the mathematical framework for an exemplary embodiment of the grand unified modular arithmetic framework used in modular computation, artificial intelligence, cryptography, and quantum computing.

FIG. 20 depicts the mathematical framework for an alternate embodiment of the grand unified modular arithmetic framework.

FIG. 21 depicts the mathematical framework for an alternate embodiment of the grand unified modular arithmetic framework.

### DETAILED DESCRIPTION OF THE INVENTION

The following description is not an admission that any of the information provided herein is prior art or relevant to the present invention, or that any publication specifically or implicitly referenced is prior art. Any publications cited in this description are incorporated by reference herein. Where a definition or use of a term is an incorporated reference is inconsistent or contrary to the definition of that term provided herein, the definition of that term provided herein applies and the definition of that term in the reference does not apply.

As used in the description herein and throughout the claims that follow, the meaning of “a,” “an,” and “the” includes plural reference unless the context clearly dictates otherwise. Also, as used in the description herein, the meaning of “in” includes “into” and “on” unless the context clearly dictates otherwise.

As used herein, the term “about” in conjunction with a numeral refers to a range of that numeral starting from 10% below the absolute value of the numeral to 10% above the absolute value of the numeral, inclusive.

As used herein, the terms “zero-free modular arithmetic” and “ZFMA” are used interchangeably throughout the disclosure.

As used herein, the terms “grand unified modular arithmetic framework,” “GUMAF,” and “GUM” are used interchangeably throughout this disclosure.

As used herein, the terms “zero-free self-contained computing system,” “ZSCS,” and “SCG” are used interchangeably throughout this disclosure.

The present invention is directed to a grand unified modular arithmetic framework (GUMAF) that transforms modular arithmetic, factorization, and recursive number structures by introducing a zero-free arithmetic system (Cyc(9)), which replaces 0 with 9 to maintain perfect numerical continuity. More specifically, by restructuring number theory through a self-replicating, fractal-like modular system, GUMAF provides predictive rules for prime distribution, semi-prime growth, and modular periodicity. In addition, GUMAF comprises a zero-free, Cyc(9) modular arithmetic system ensuring that all modular cycles remain closed and self-contained; a self-referencing multiplication lattice, where prime and semi-prime positioning follows recursive diagonal symmetry; new laws of factorization, including reverse modular decomposition, prime anchoring, and modular prime-semi-prime relationships; and a fractal expansion model for modular summations, ensuring that digital roots and modular residues follow predictable, periodic laws.

The grand unified modular arithmetic framework is capable of being integrated into various applications. In computing, GUMAF provides a modular framework for error-free digital computations. In cryptography, GUMAF enhances security algorithms by stabilizing cryptographic calculations. In physics and engineering, GUMAF replaces singularities in physics equations with modular stability conditions. While not a direct resolution to singularities, GUMAF provides a framework that avoids infinite divergences by ensuring stable oscillations near critical points aligning with quantum gravity's approach of replacing continuous infinities with discrete structures. Modular oscillations replace singularities ensuring continuity even in extreme computational or physical scenarios by stabilizing values though modular transitions. In addition, GUMAF models quantum mechanics and relativistic systems without undefined states. GUMAF enables stable synchronization in distributed computations and financial transactions.

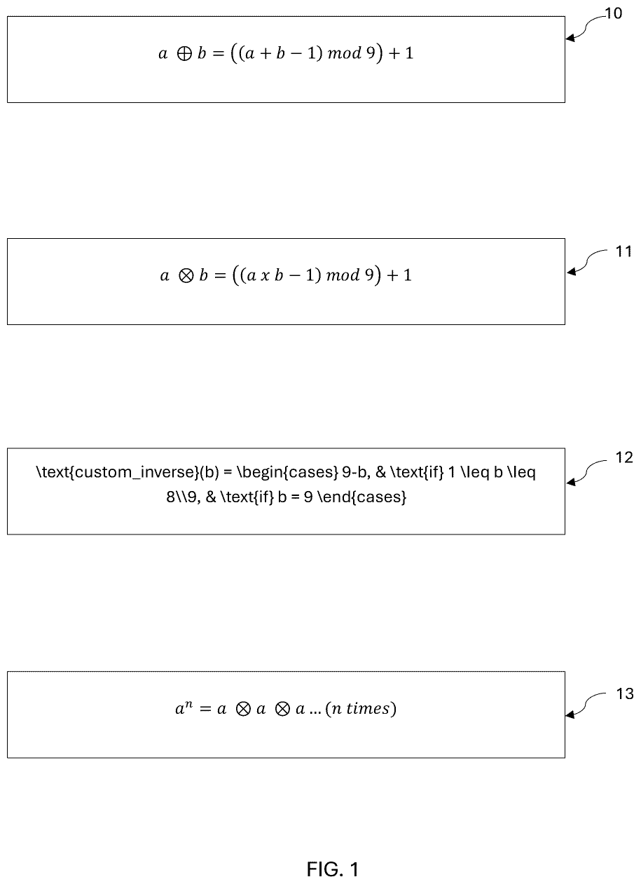

FIG. 1 depicts the mathematical structure used in an exemplary embodiment of grand unified modular arithmetic framework 100, wherein GUMAF 100 comprises addition 10, multiplication 11, division 12, and exponentiation 13. The equation addition 10 ensures that if a+b≡0 mod 9, the result is 9, not 0. The equation multiplication 11 guarantees that all products stay within the set {1-9}, eliminating undefined cases. Division 12 is a definition of an inverse function ensuring every number has a valid modular inverse. Exponentiation 13 retains modular closure for repeated operations.

Grand unified modular arithmetic framework 100 uses fractal digital root symmetry. Digital roots follow a cyclical pattern which aligns with the structure set forth in GUMAF 100, wherein every number reduces to a single-digit residue within {1-9}, reinforcing the fractal nature of arithmetic cycles.

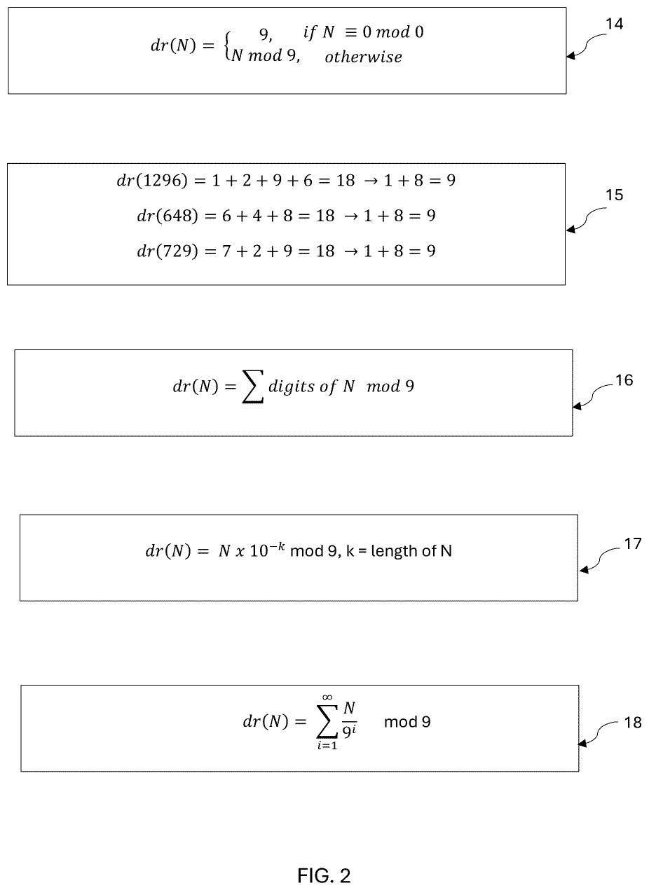

FIG. 2 depicts the fractal digital root consistency used in an exemplary embodiment of grand unified modular arithmetic framework 100, wherein GUMAF 100 comprises formula 14. Formula 14 states that for any digital root N, there are two possible outcomes. Either N is equal to 9 otherwise N mod 9. A digital root is a self-replicating numerical fingerprint obtained by recursively summing digits until a single digit remains. Example 15 shows formula 14 in use for N equals 1296, N equals 648, and N equals 729. Digital root consistency ensures numerical self-correction; cycles persist across infinite scales, forming a universal mathematical fractal; and eliminates error drift in computing and artificial intelligence.

In another embodiment, alternate digital root computation methods include method one 16, method two 17, and method three 18, wherein method one 16 comprises recursive summation, method two 17 comprises logarithmic power reduction, and method three 18 comprises fractal logarithmic collapse (see FIG. 2).

GUMAF 100 uses 1296 as a universal stabilizer due to its strong divisibility properties and its alignment with fundamental time measurements (e.g., 86,400 seconds per day=1296×66.666 . . . ). In alternate embodiments, other scalable anchors may be used (e.g., 2025).

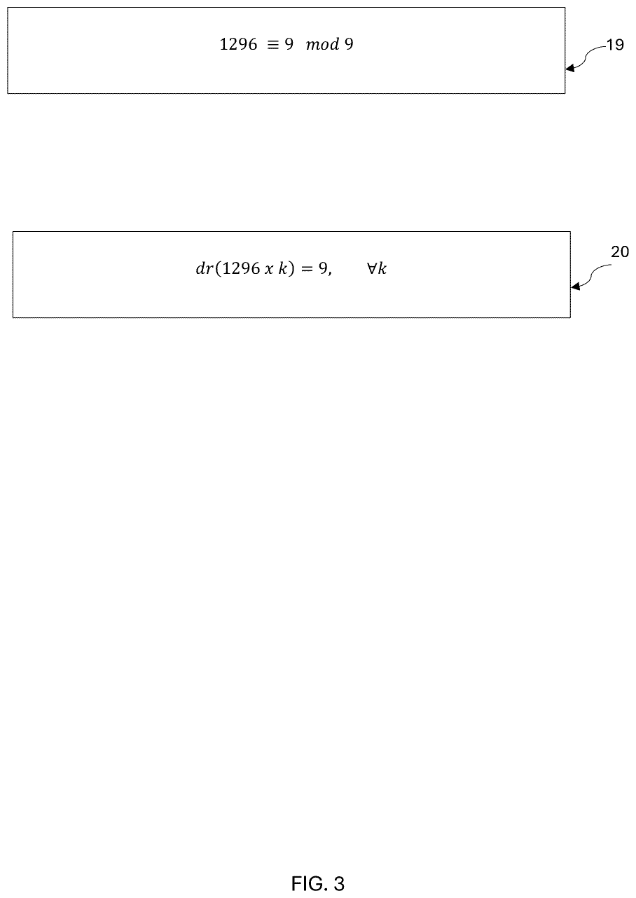

FIG. 3 depicts the scalable anchoring principle used in an exemplary embodiment of grand unified modular arithmetic framework 100, wherein GUMAF 100 comprises the scalable anchoring principle of 1296 due to its highly divisible and stable nature. The digital root of 1296 is 9 ensuring cyclic consistency. In Addition, 1296 is capable of being used in time cycles and bridges small- and large-scale systems. In this embodiment, the modular relationship with cyc(9) is 1296≡9 mod 9 (19) and all multiples of 1296 collapse to 9 (20) proving 1296 is a natural quantum stabilizer.

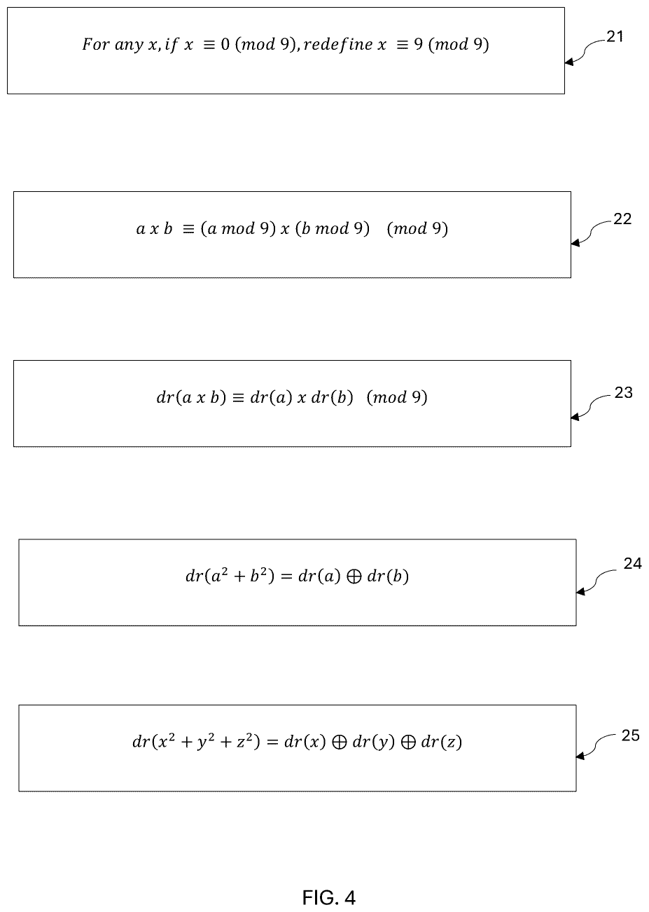

FIG. 4 depicts the axiomatic foundations used in an exemplary embodiment of grand unified modular arithmetic framework 100. In classical modular arithmetic, modular congruences assume: a≡b (mod n), which allows for the presence of 0 as a residue class. However, zero disrupts modular consistency, leading to undefined behaviors and factorization patterns. Replacing 0 with 9 creates a fully cyclical number system {1, 2, 3, . . . , 9}. Instead GUMAF 100 follows:

$$For any x , if x ≡ 0 ( mod 9 ) , redefine x ≡ 9 ( mod 9 ) \qquad ( 21 )$$

In an exemplary embodiment, GUMAF 100 comprises the following key properties: (1) every number retains its modular identity across cycles, (2) no gaps or singularities exist within modular sequences, and (3) all factorization and multiplicative relationships maintain a self-similar, fractally expanding structure.

In one embodiment, GUMAF 100 redefines modular congruences for factorization, wherein zero is replaced with a self-referencing numerical boundary to transform modular congruences. The following congruence ensures that products cycle predictably through a fractal pattern, with multiplication preserving digital root symmetry:

$$a x b ≡ ( a mod 9 ) \times ( b mod 9 ) ( mod 9 ) \qquad ( 22 )$$

In an exemplary embodiment, the key theorem comprises the following digital root function, dr(x): dr(a×b)=dr(a)×dr(b) (mod 9) (23). In this embodiment, factorization collapses into modular residue lookup tables, avoiding brute-force searches.

In another embodiment, GUMAF 100 is capable of extending modular relationships into recursive structures by: dr(a²+b²)=dr(a)⊕dr(b) (24), scaling into a three-dimensional fractal modular expansion of: dr(x²+y²+z²)=dr(x)⊕dr(y)⊕dr(z) (25). In this embodiment, summation and multiplication of factorized components remain invariant across lattice depth confirming the self-similarity of modular operations.

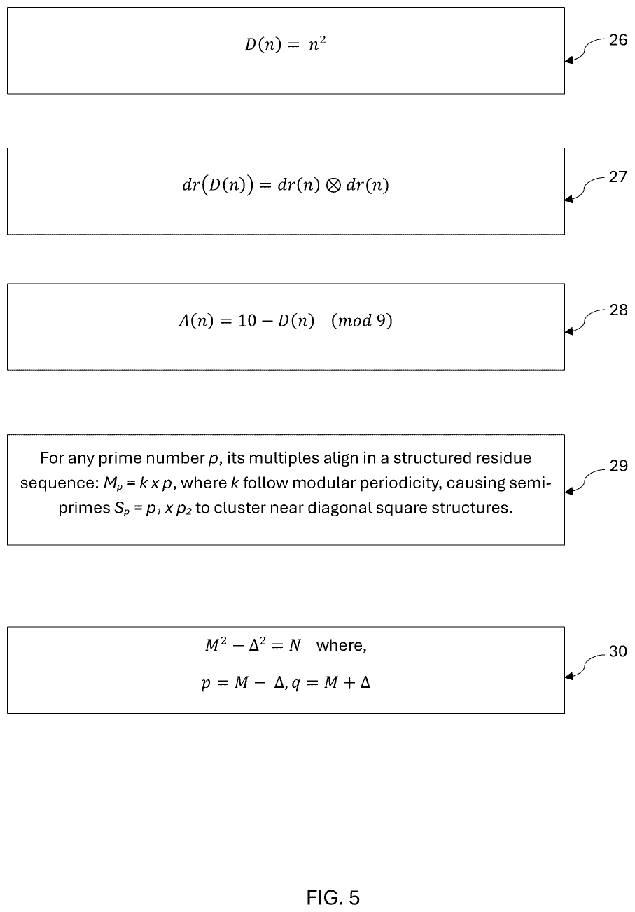

FIG. 5 depicts the multiplication lattice and the prime factorization laws used in an exemplary embodiment of grand unified modular arithmetic framework 100. In this embodiment, GUMAF 100 comprises a multiplication lattice, wherein the multiplication lattice provides a structural method to position prime numbers, semi-prime numbers, and multiples thereof in a recursive, self-correcting system that follows modular periodicity and fractal expansion laws. In a traditional multiplication table, perfect squares appear along the diagonal (D(n)=n²)) (26), splitting the multiplication table into two symmetrically structured halves, aligning prime-based factorization along predictable modular patterns.

In this embodiment, GUMAF 100 comprises prime and semi-prime alignment to the prefect square diagonal, dr(D(n))=dr(n)⊗dr(n) (27), proving that every squared number retains modular periodicity, reinforcing recursion and factorization symmetry.

In another embodiment, GUMAF 100 comprises an anti-diagonal, A(n)=10-D(n) (mod 9) (28), ensuring numerical mirroring of modular residues. Anti-diagonal 28 serves as an inverse symmetry structure, mapping modular periodic reflections of semi-prime structures.

Prime numbers are isolated in modular sequences, whereas semi-prime numbers align with predictable diagonal structures. Prime factorization positioning, for example, states for any prime number, p, its multiples align in a structured residue sequence, Mₚ=k×p, where k follows modular periodicity, causing semi-primes Sₚ=p₁×p₂ (29) to cluster near diagonal square structures. In this embodiment, the products of the prime numbers (semi-primes) form structured periodic bands that align with the multiplication lattice at predictable intervals.

Factorizing N is traditionally an exponential brute-force problem. However, using GUMAF 100 allows for factorization that follows a structured decomposition model. Defining modular prime anchoring as M²−Δ²=N, where p=M−Δ, q=M+Δ (30) turns factorization into a lookup process within a structured multiplication lattice instead of a search for factors. In this embodiment, M represents the nearest prime-semi-prime modular anchor, and delta, Δ, is a structured periodic correction factor.

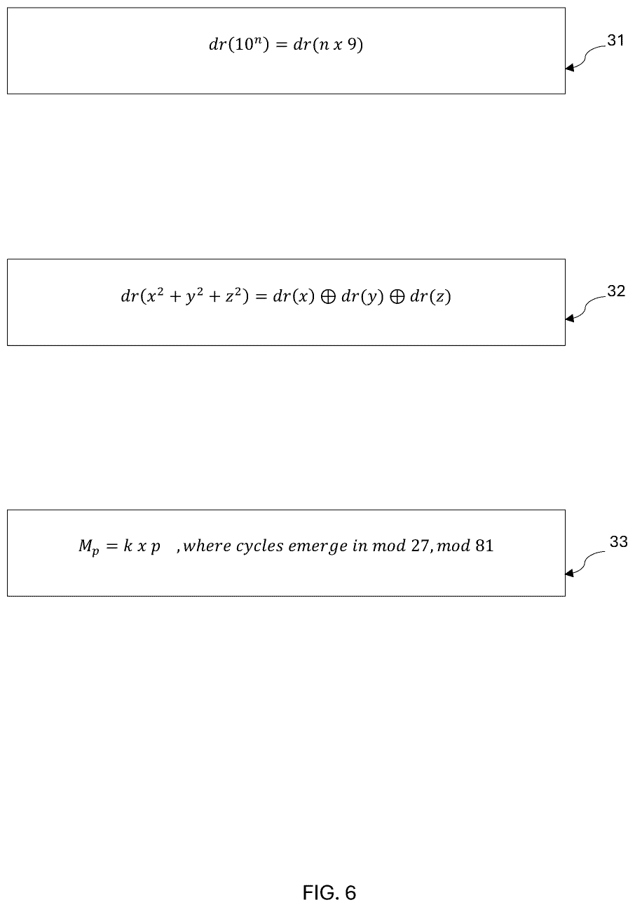

FIG. 6 depicts the advanced modular laws and fractal properties used in an exemplary embodiment of grand unified modular arithmetic framework 100. In another embodiment, GUMAF 100 extends the multiplication lattice into three dimensions, wherein the recursive modular cycles align with logarithmic periodicity and prime-semi-prime positioning. Using a logarithmic scaling of modular growth, dr(10ⁿ)=dr(n×9) (31), confirms that modular periodicity is scale-invariant. Additionally, factorization in higher dimensions follows a logarithmic self-similarity, governed by powers of 9.

In an embodiment, GUMAF 100 comprises a recursive modular structure that follows 9-periodicity. Modular residue growth in higher dimensions is shown using dr(x²+y²+z²)=dr(x)⊕dr(y)⊕dr(z) (32), ensuring that higher-order prime products remain cyclically stable in structured periodicity. As modular growth progresses, prime factors and their expansions maintain modular consistency by following predictable anchoring laws. For example, prime multiples in three-dimensional modular space, Mₚ=k×p, where cycles emerge in mod 27 and mod 81 (33) ensure higher-order modular anchoring in a self-correcting structure.

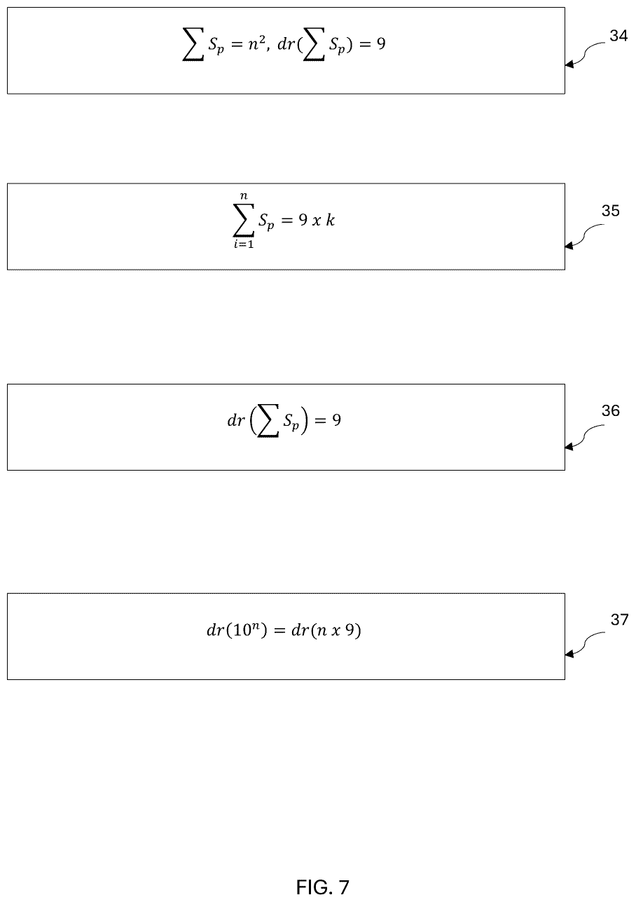

FIG. 7 depicts the summation laws and the digital root fractals used in an exemplary embodiment of grand unified modular arithmetic framework 100, wherein GUMAF 100 summation follows a structured collapse into periodic modular sequences. Summing prime-semi-prime structures results in modular residue preservation, ΣSₚ=n², dr(ΣSₚ)=9 (34), collapsing into structured periodicity ensuring modular continuity. All prime-semi-prime sequences maintain modular residue alignment in summation structures. Using the modular summation law,

$${\sum }_{i = 1}^{n} {S}_{p} = 9 \times k , \qquad ( 35 )$$

where all summations eventually collapse into a cyclic residue of 9, confirming digital root behavior self-corrects.

Summation collapses into a predictable cyclic sequence, dr(ΣSₚ)=9 (36), ensuring every structured sum aligns to digital root preservation. Every sum in structured modular spaces exhibits a harmonic residue cycle.

The recursive behavior of factorization and summation cycles follows logarithmic recursive expansion, dr(10ⁿ)=dr(n×9) (37). Recursive modular expansions preserve factorization laws across logarithmic scaling.

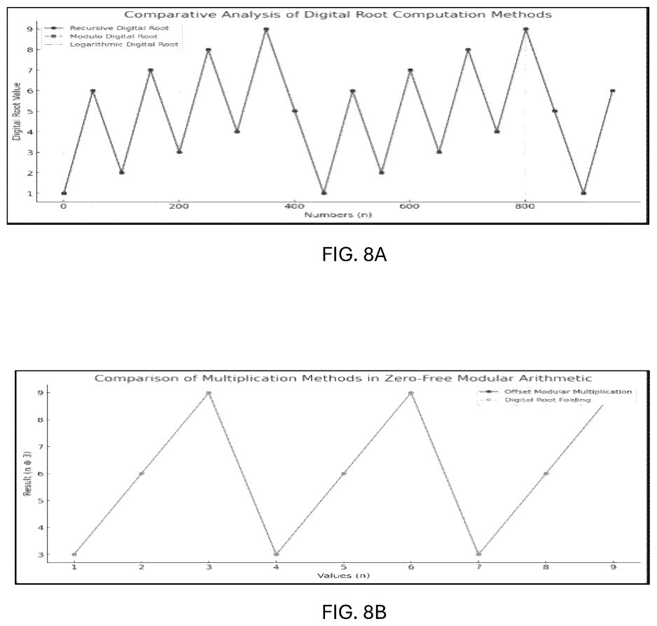

FIG. 8A depicts a graph of the comparative analysis of three digital root computation methods. The three methods depicted are recursive digital root, modulo digital root, and logarithmic digital root. FIG. 8B depicts a graph of the comparison of multiplication methods used in zero-free modular arithmetic. Both graphs visually confirm GUMAF 100 comprises multiple, independent, mathematically equivalent methods to perform the same computations.

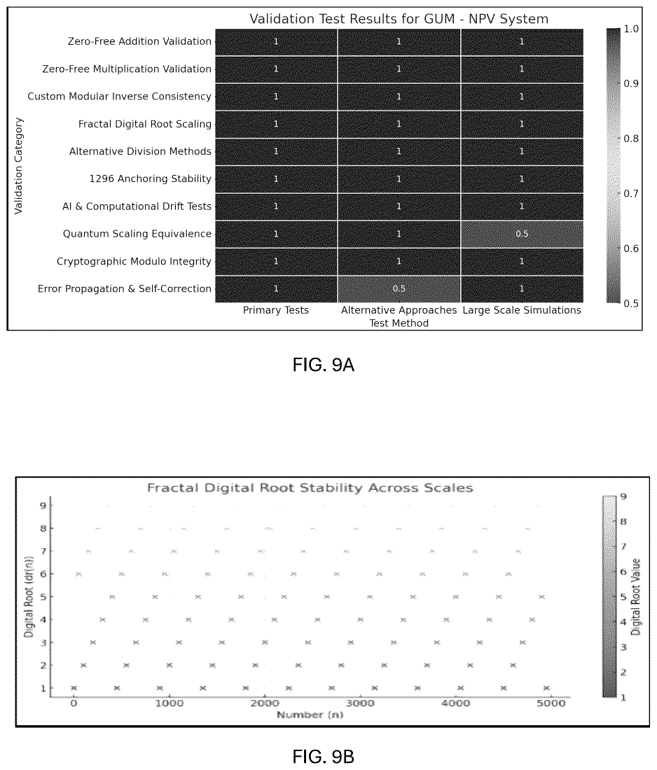

FIG. 9A depicts a chart of the validation test results for grand unified modular arithmetic framework 100. FIG. 9B depicts a chart of the fractal digital root stability across scales for grand unified modular arithmetic framework 100.

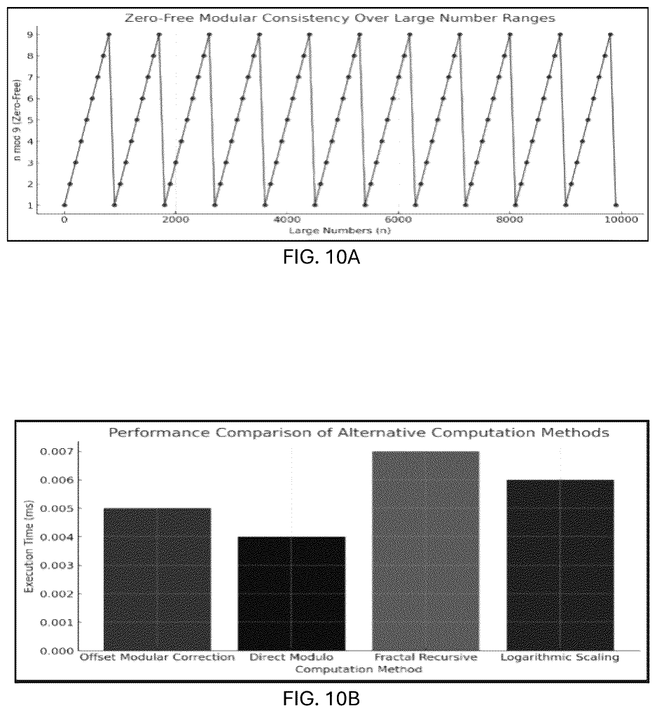

FIG. 10A depicts a chart of the zero-free modular consistency over large number ranges for grand unified modular arithmetic framework 100. FIG. 10B depicts a bar chart of the performance comparison of alternative computation methods.

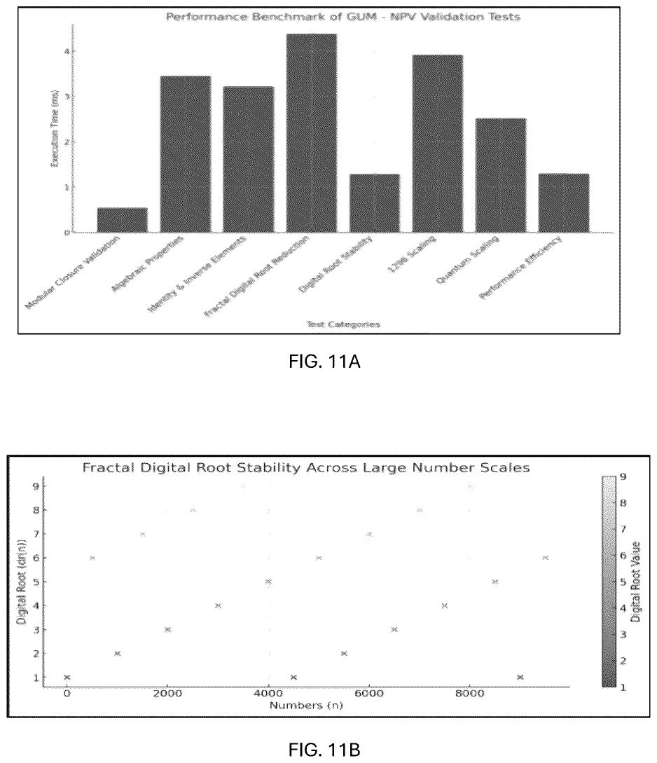

FIG. 11A depicts a bar chart of the performance benchmark validation tests for grand unified modular arithmetic framework 100. FIG. 11B depicts a chart of the fractal digital root stability across large number scales for grand unified modular arithmetic framework 100.

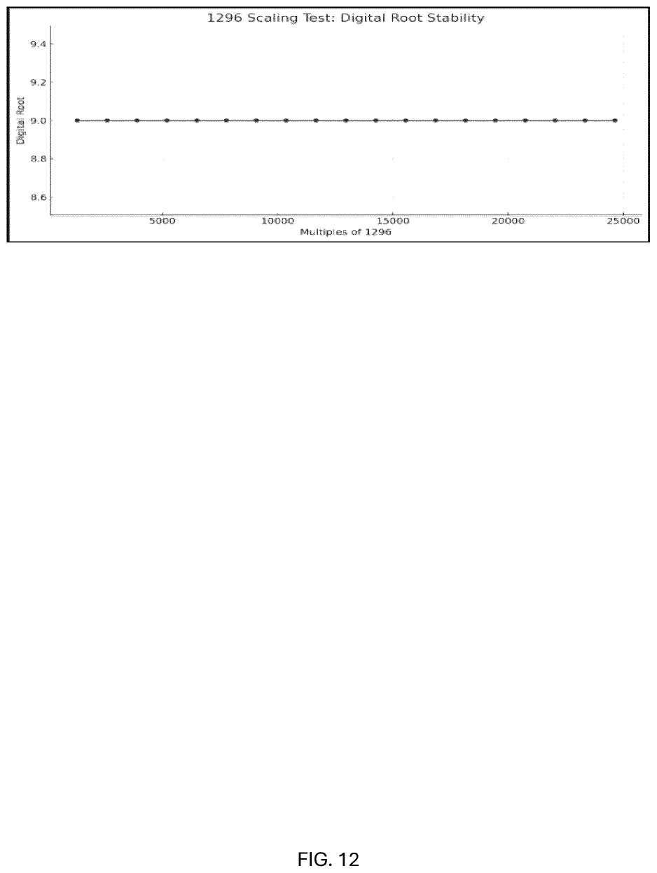

FIG. 12 depicts a chart of the 1296 scaling test for digital root stability for grand unified modular arithmetic framework 100.

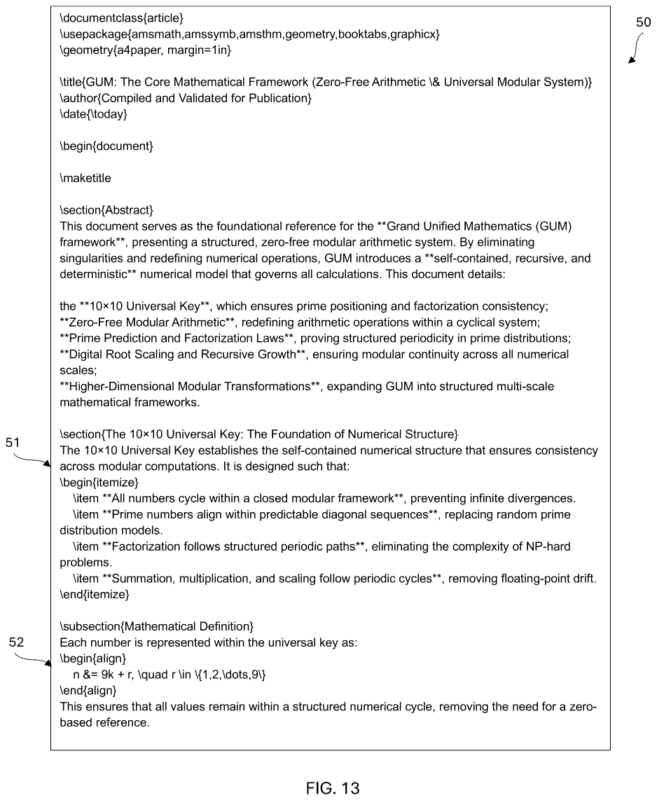

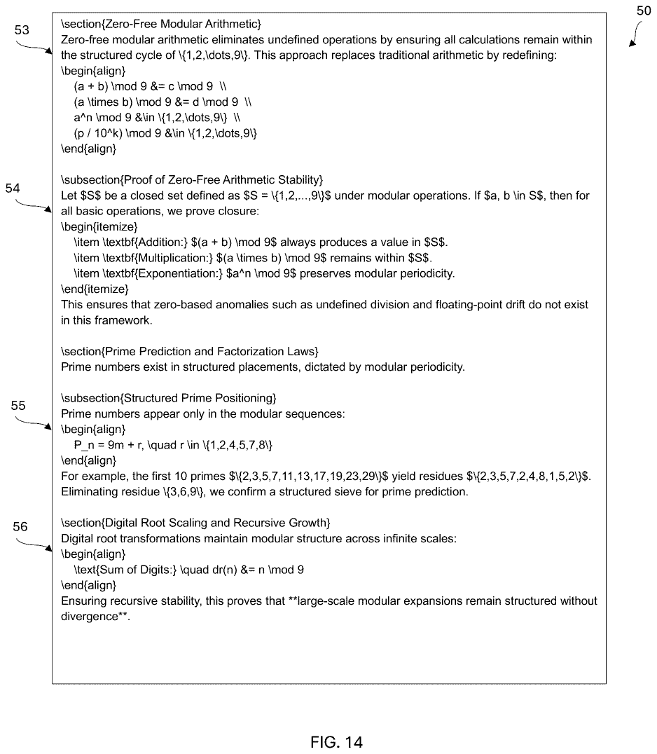

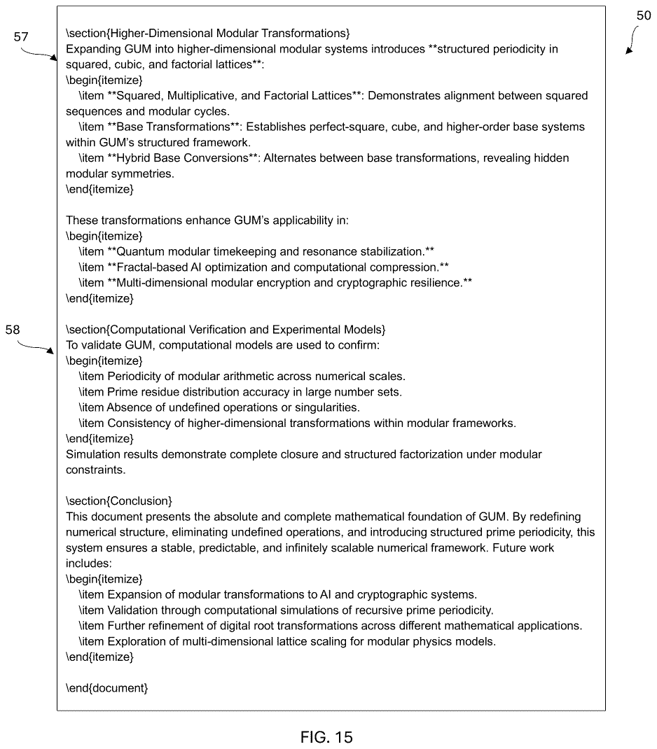

FIGS. 13-15 depicts the process for core mathematical structure 50 used in an exemplary embodiment of grand unified modular arithmetic framework 100, wherein GUMAF 100 comprises the following steps: establishing the self-contained numerical structure that ensures consistency across modular computations (51); representing each number from a universal key ensuring values remain within a structured numerical cycle (52); replacing traditional arithmetic with zero-free modular arithmetic eliminating undefined operations (53); creating a closed set of {1-9} for all basic operations including addition, multiplication, and exponentiation ensuring zero-based anomalies do not exist in the framework (54); ensuring prime numbers only appear in specified modular sequences eliminating residue and confirming a structured sieve for prime prediction (55); ensuring digital root transformations maintain modular structure across infinite scales (56); introducing structured periodicity in squared, cubic, and factorial lattices expanding into higher-dimensional modular systems (57); and validating core mathematical structure 50 using computational models (58).

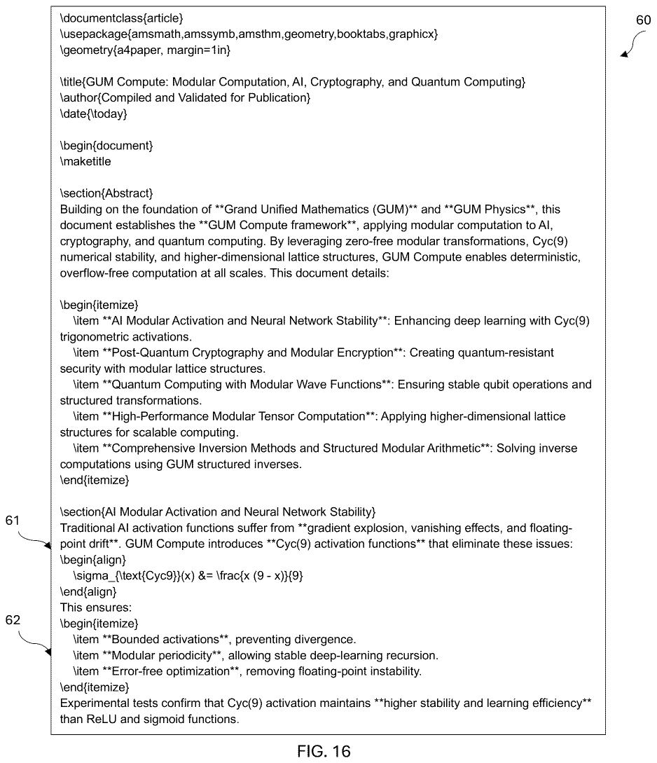

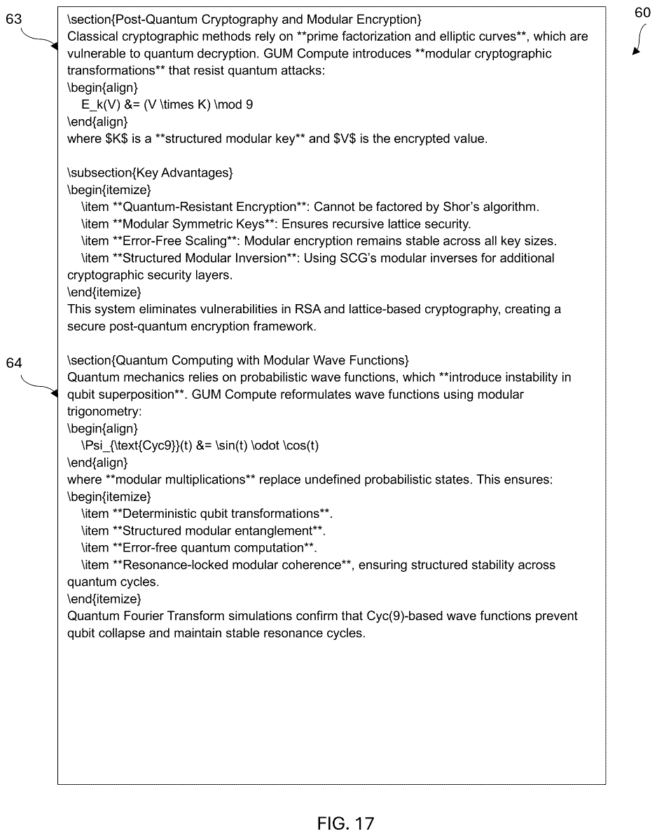

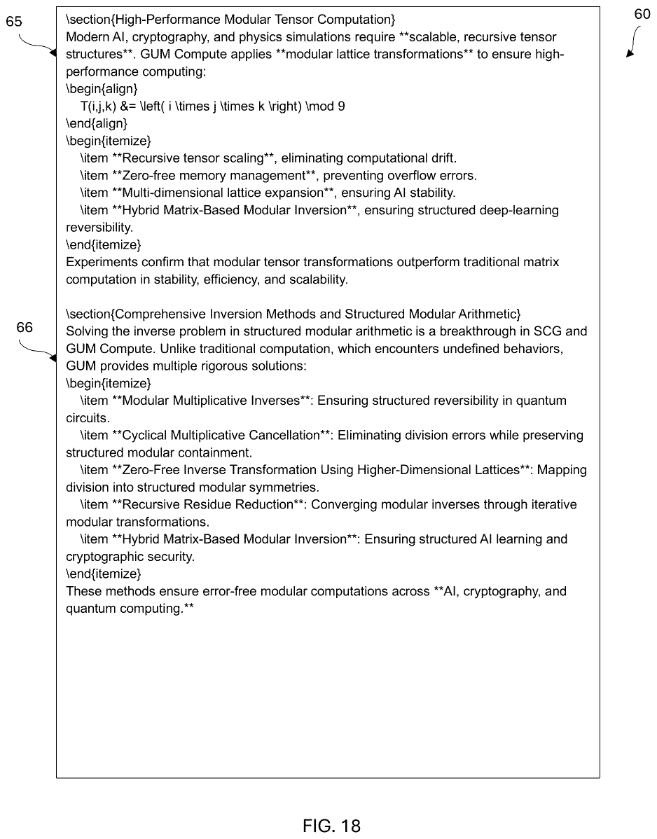

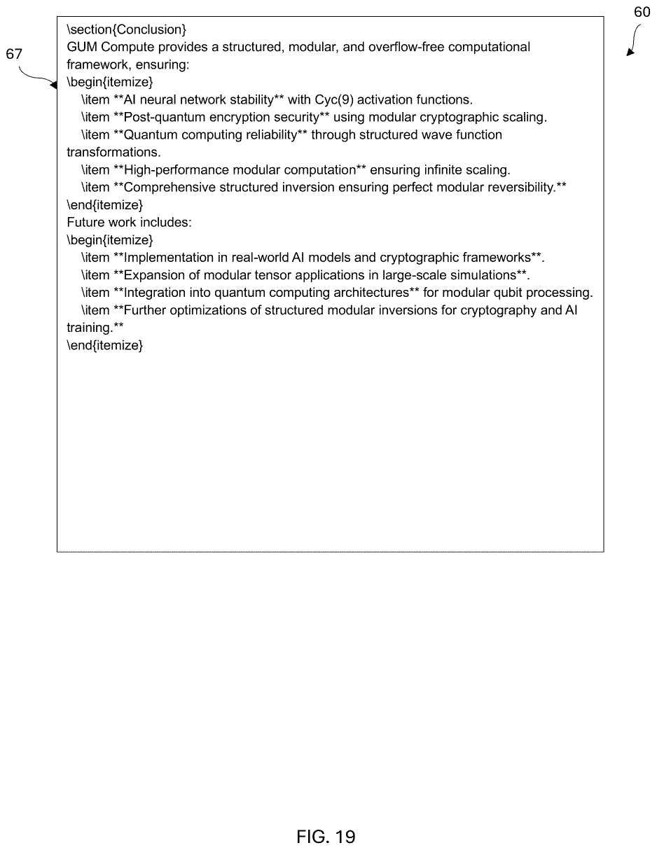

FIGS. 16-19 depicts mathematical structure 60 for an exemplary embodiment of grand unified modular arithmetic framework 100 used in modular computation, artificial intelligence (AI), cryptography, and quantum computing, wherein mathematical structure 60 comprises the following steps: introducing Cyc(9) activation functions eliminating issues with gradient explosion, vanishing effects, and floating point drift (61); ensuring bounded activations preventing divergence, modular periodicity allowing stable deep-learning recursion, and error-free optimization removing floating-point instability (62); introducing modular cryptographic transformations resisting quantum attacks (63); reformulating wave functions using modular trigonometry preventing qubit collapse and maintaining stable resonance cycles (64); applying modular lattice transformations ensuring high-performance computing (65); providing multiple solutions to common problems in traditional computation (66); and providing a structured, modular, and overflow-free computational framework ensuring AI neural network stability with Cyc(9) activation functions, post-quantum encryption security using modular cryptographic scaling, high-performance modular computation ensuring infinite scaling, and comprehensive structured inversion ensuring perfect modular reversibility (67).

Advantages for modular cryptographic transformations presented in step 63 comprises quantum-resistant encryption that cannot be factored by Shor's algorithm, modular symmetric keys ensuring recursive lattice security, error-free scaling ensuring modular encryption remains stable across all key sizes, and structured modular inversion by using SCG's modular inverses for additional cryptographic security layers. In addition, mathematical structure 60 is capable of eliminating vulnerabilities in Rivest-Shamir-Adleman (RSA) and lattice-based cryptography, creating a secure post-quantum encryption framework.

Solutions to the common problems in traditional computation presented in step 66 comprises modular multiplicative inverses ensuring structured reversibility in quantum circuits, cyclical multiplicative cancellation eliminating division errors while preserving structured modular containment, zero-free inverse transformation using higher-dimensional lattices mapping division into structured modular symmetries, recursive residue reduction converging modular inverses through iterative modular transformations, and hybrid matrix-based modular inversion ensuring structured AI learning and cryptographic security.

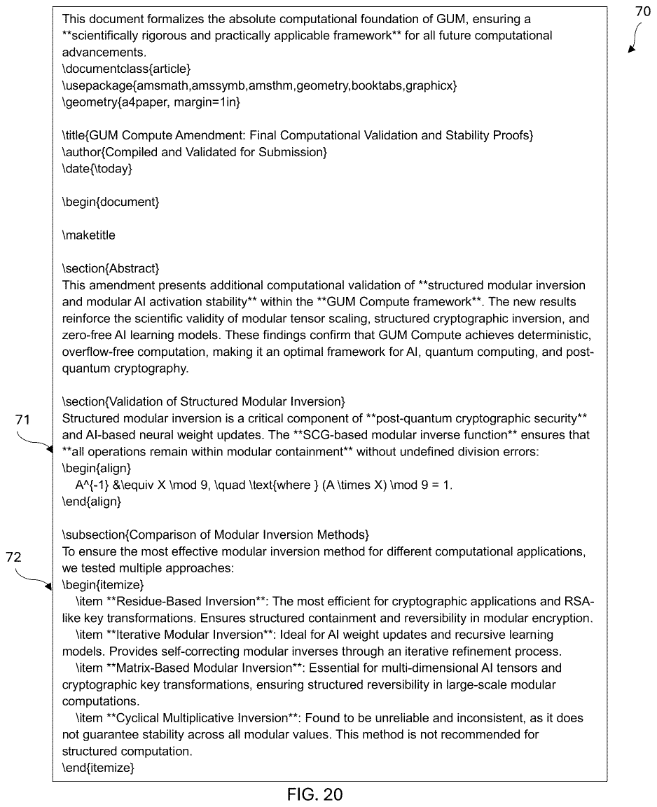

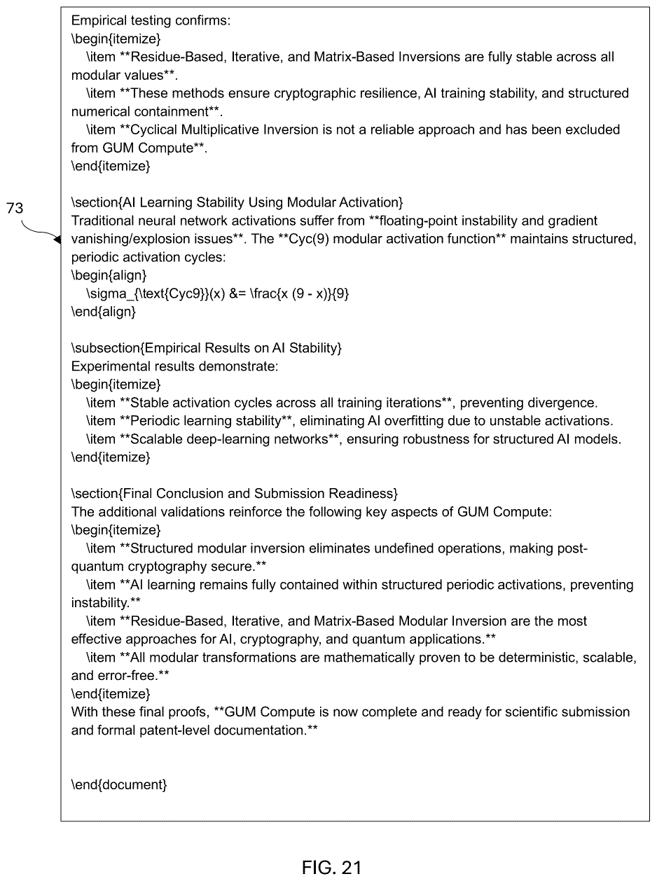

FIGS. 20-21 depicts amended mathematical structure 70 for an alternate embodiment of grand unified modular arithmetic framework 100, wherein amended mathematical structure 70 comprises the following steps: validating the SCG-based modular inverse function ensuring that all operations remain within modular containment without undefined division errors (71); comparing modular inversion methods to ensure most effective method for each computational applications (72); and using Cyc(9) modular activation function to maintain structured, periodic activation cycles (73);

Thus, specific embodiments of grand unified modular arithmetic framework 100 have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1-17. (canceled)

18. A grand unified modular arithmetic framework to improve modular arithmetic, factorization, and recursive number structures used in digital computing comprising:
a. a plurality of cycles, wherein every number retains its modular identity across said plurality of cycles;
b. a plurality of modular sequences, wherein said plurality of modular sequences comprise no gaps or singularities;
c. a plurality of factorization and multiplicative relationships comprising a self-similar, fractally expanding structure.

19. The grand unified modular arithmetic framework as recited in claim 18, wherein said grand unified modular arithmetic framework redefines modular congruences for factorization, wherein zero is replaced with a self-referencing numerical boundary to transform modular congruences.

20. The grand unified modular arithmetic framework as recited in claim 18, wherein said grand unified modular arithmetic framework comprises the following digital root function, dr(x): dr(a×b)≡dr(a)×dr(b), wherein factorization collapses into modular lookup tables.
